(19) United States
(12) Patent Application Publication
(10) Pub. No.: US 2004/0150877 A1
(43) Pub. Date: Aug. 5, 2004

(54) Optical arrangement having a lens of single-axis, double-refracting material

(76) Inventors: Artur Hogele, Oberkochen (DE); Karl-Heinz Schuster, Konigsbronn (DE)

Correspondence Address: Walter Ottesen, Patent Attorney, P.O. Box 4026, Gaithersburg, MD, 20885-4026, US

(21) Appl. No.: 10/763,321

(22) Filed: Jan. 26, 2004

(30) Foreign Application Priority Data
Jan. 24, 2003 (DE) 103 02 765.3

(51) Int. Cl. G02B 13/14

(52) U.S. Cl. 359/355

(57) ABSTRACT

An optical arrangement is equipped with lenses (22, 42) of double-refracting optically single-axis material in a pupillary plane (21, 41) and in tangentially polarized light or radially linearly polarized light. In this way, and for 157 nm lithography, MgF₂ is usable as additional lens material with a deviating refracting index for achromatization with CaF₂/BaF₂.

### CROSS REFERENCE TO THE RELATED APPLICATION

This application claims priority of German patent application no. 103 02 765.3, filed Jan. 24, 2003, the entire content of which is incorporated herein by reference.

### FIELD OF THE INVENTION

The invention relates to an optical arrangement having at least one lens, a light beam, an optical axis and a plane perpendicular to the optical axis. The light beam is polarized tangentially or radially in the plane with respect to the optical axis and the lens is arranged next to or in the plane.

### BACKGROUND OF THE INVENTION

U.S. Pat. No. 6,597,498 is incorporated herein by reference and discloses an arrangement wherein MgF₂ serves as a lens material and the light wavelength lies in a very narrow interval about the characterizing wavelength (at 119 nm). Here, the MgF₂ is not double refracting.

U.S. patent publication 2001/0019404 is incorporated herein by reference and discloses a method for microlithographic image generation wherein microlithography with tangentially polarized illumination is explained in detail as is the preparation thereof. However, no suggestion is provided in this publication as to a connection to refraction characteristics of the lens material. Systems having radial polarization are also discussed in this publication.

U.S. patent application Ser. No. 09/451,505, filed Nov. 30, 1999 (corresponding to German patent publication 199 29 701), is incorporated herein by reference and touches upon MgF₂ as a lens material for the DUV/VUV range. However, this material is deemed to be unsuitable because of the double refraction.

U.S. Pat. No. 5,867,315 discloses a polarization-selective bifocal lens comprising two component lenses of which at least one component lens is made of an optically single-axis, double-refracting crystal. In one embodiment, a composite lens is referred to and is made of two crystal lenses having principal axes which are mutually orthogonal. One of the principal axes is orientated in a direction of the optical axis or form symmetry axis. In this way, an optical member is shown which operates as a planar plate for one polarization direction and which operates as a lens in a direction which is perpendicular to the first direction. This is utilized in the scan read-out of data carriers, that is, with a small field and almost paraxial. The incident light is unpolarized and the outgoing light is split into two beams which are linearly polarized orthogonally to each other.

### SUMMARY OF THE INVENTION

It is an object of the invention to make additional materials accessible to optical systems in the DUV/VUV wavelength range with these additional materials being especially advantageous with respect to achromatization without it being necessary to maintain tight restrictions as to the wavelength.

The optical arrangement of the invention can be described with respect to an optical axis and includes: a plane perpendicular to the optical axis; a light source for generating a light beam along the optical axis and the light of the light beam in the plane being polarized either tangentially to the optical axis or radially with respect to the optical axis; at least one lens mounted in or next to the plane; the lens being made of single-axis, double-refracting material defining an optical crystal axis; and, the optical crystal axis being aligned parallel to the optical axis of the optical arrangement. Said optical axis is a general axis of reference, which may be folded (by mirrors), generally an axis of symmetry of the curvatures of surfaces contacted by a light beam. Decentered elements, tilted elements, off-axis fields or pupils and light beams asymmetric thereto are possible.

Thus, especially MgF₂ is provided as a material for the lens and this material has up to now been rejected because of being double refracting except for the characterizing wavelength of 119 nm.

U.S. patent publication 2001/0019404 discloses that the tangential or radial polarization, which is needed as a condition precedent for the use of double-refracting material, has advantages also for image contrast and can be made available in different ways. According to the invention, it is therefore provided that all lenses, which consist of optically single-axis double-refracting material, are aligned with the optical crystal axis parallel to the optical axis.

According to another feature of the invention, the lens made of a single-axis, double-refracting material (of which there can also be several examples in an arrangement) is mounted in or near a pupillary plane.

In this way, residual disturbances from the double refraction are independent of field. Accordingly, a uniform limiting of the resolution capacity occurs but not a distortion or the like.

According to another feature of the invention, it is ensured that residual disturbances remain very small with the limit value of the numerical aperture of the lens of 0.1. The numerical aperture of an optical system (for example, a projection objective having an arrangement according to the invention) is thereby not limited, especially when the lens is arranged in the region of the pupillary plane (system aperture plane).

According to another feature of the invention, the light source is a laser and preferably an excimer laser which, because of geometry and reflection characteristics of the resonator, couples out radially polarized light or tangentially polarized light.

Pursuant to another feature of the invention, the optical arrangement includes at least a second lens made of a material different from the first lens. This material is preferably crystal and can be especially CaF₂ or BaF₂. This is a preferred application of the invention for partial achromatization. In the deep UV-range below the 193 nm excimer laser line (that is, especially at the 157 nm F₂-excimer laser line), there is only one tightly-limited selection of transparent and resistant lens materials, namely, practically only fluoride crystals and fluoride-doped quartz glass. Only CaF₂ is already established in microlithography from the 193 nm technology and BaF₂ is also proven in optics. MgF₂ would be advantageous as a partner for achromatization because of its non-problematical manufacture and processing.

A microlithographic projection exposure system is an advantageous system wherein the optical arrangement according to the invention is utilized. The preferred wavelength here is 157 nm of the F₂ excimer laser. For longer wavelengths (for example, 193 nm), achromatized objectives made of CaF₂ and quartz glass are available so that no demand pressure is present for additional materials.

For the most demanding microlithographic optics, material having a disturbing polarization-specific characteristic (double refraction) is made useful via a targeted adjustment of the polarization and an optimal location of use in the optical system.

### BRIEF DESCRIPTION OF THE DRAWINGS

The invention will now be described with reference to the drawings wherein:

FIG. 1 is a schematic of a microlithographic projection exposure system according to an embodiment of the invention; and,

FIG. 2 is a schematic showing the ray paths at the reticle and the pupillary plane.

### DESCRIPTION OF THE PREFERRED EMBODIMENTS OF THE INVENTION

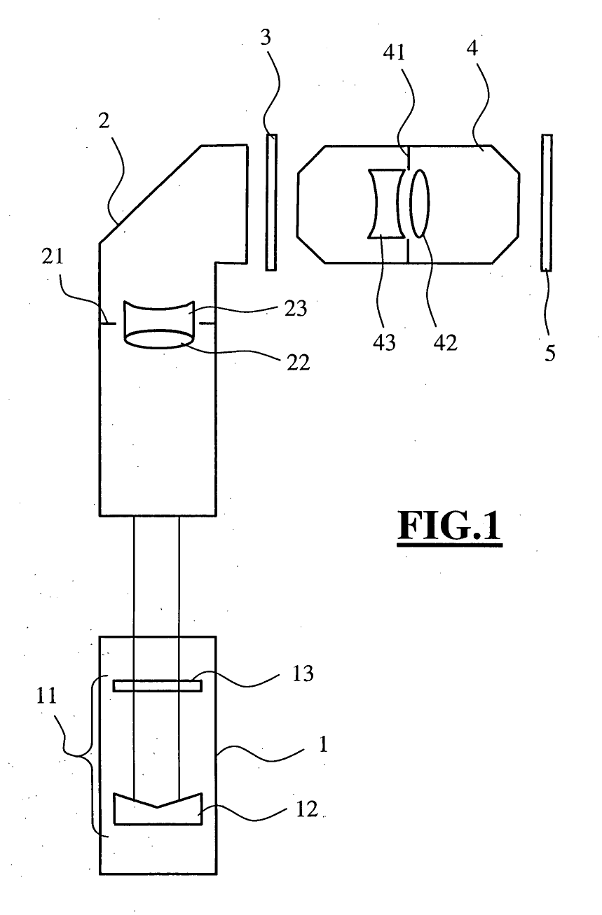

The microlithographic exposure system shown schematically in FIG. 1 includes a laser 1 (F₂ excimer laser 157 nm) as a light source. The laser 1 includes a resonator 11 which includes a second hollow-conically shaped end mirror 12 in addition to a planar coupling mirror 13. This end mirror 12 is highly reflective for S-polarization but highly transmissive for P-polarization. Accordingly, the end mirror is a source for radially orientated linear polarized light. Additional details of the F₂ laser as a light source of a projection exposure system (especially for bandwidth narrowing and wavelength stabilization) are known and are not described here. The same applies to beam guidance systems and the like.

The illumination system 2 is known per se and includes elements (not shown) such as a light mixer/integrator, aperture adaptation, reticle masking, shutter, beam deflection, et cetera. The illumination system 2 includes an objective having a pupillary plane 21 and a lens 22 is mounted directly in the region of the pupillary plane 21. The lens 22 is made of MgF₂ and its crystal axis lies perpendicular to the pupillary plane 21 and parallel to the optical axis. The lens 22 is provided and is suitable for the achromatization of the objective in combination with a lens 23 shown by way of example. The lens 23 is made of CaF₂ or BaF₂. Details can be optimized in accordance with the described basic idea utilizing commercial optic-design programs.

With this illumination system, the reticle 3 is illuminated. The pattern of the reticle 3 is imaged by the projection objective 4 on the object 5, that is, for example, on a microelectronic wafer.

The objective 4 can be of any configuration suitable for microlithography and having extreme resolution, freedom of distortion, a large image field and a high image end aperture (more than 0.6 to over 0.9, with immersion also above 1.0). Purely refractive objectives such as catadioptric objectives of various known concepts and objectives having diffractive/binary elements can be used.

According to the invention, a lens 42 made of optically single-axis, double-refracting material is disposed in the vicinity of the pupillary plane (the objective can have several pupillary planes if it operates with intermediate images). The lens 42 is made especially of MgF₂ whose primary axis is in the direction of the optical axis perpendicular to the pupillary plane 41. The lens 42 functions for chromatic correction of the additional optical elements of the projection objective 4. These elements are represented by lens 43 made of CaF₂ or BaF₂. According to the arrangement of the double-refracting lens 42 of the invention, this lens 43 can also be optimized by means of commercial optic-design programs.

The following applies for compensating the double-refractive effects in combination with the special tangential polarization, the crystal orientation and the position of the lens 42 near the pupillary plane 41 (or the lens 22 near the pupillary plane 21):

A light beam, whose polarization is perpendicular to the plane which plane is formed by the propagation direction and the crystal axis, is therefore a proper ray and experiences no double refraction when passing through the crystal. For such a ray, the optical medium has only a refractive index n₀. If one produces a lens made of double-refracting material so that its optical axis is coincident with the crystal axis, then one achieves a constant index of refraction for all tangential rays with this polarization and even independently of the position and angle of incidence of these rays on the lens. In this way, the imaging quality of the lithographic objective is not influenced by the double refraction of the lens, which is positioned in proximity to the objective pupil, for the tangential rays.

The condition precedent therefor is supplied by an illuminating pupil, which is rotationally symmetrical with respect to polarization, or, stated otherwise, a tangential polarization of the light beam effecting the imaging.

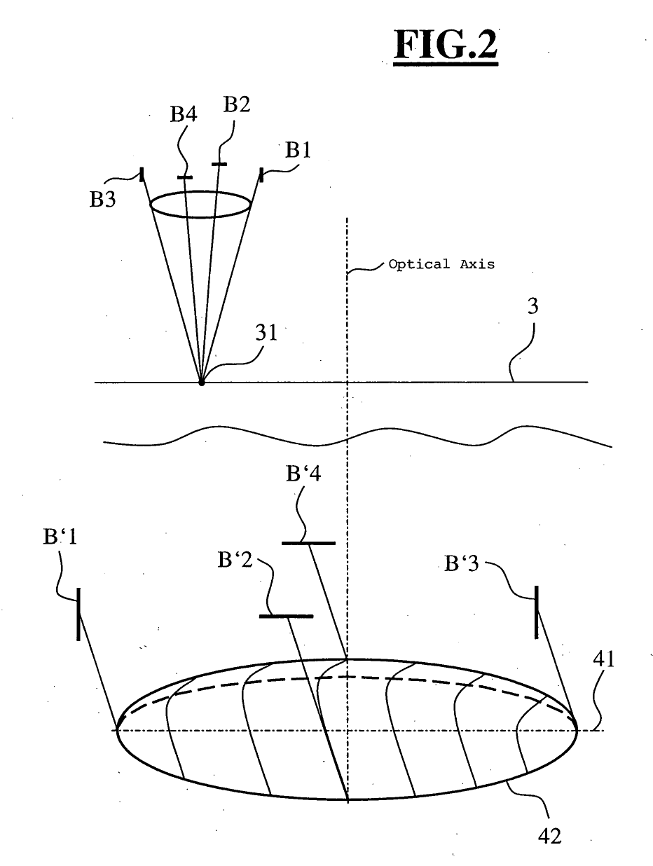

Referring to FIG. 2, the operation of a lens 42 is shown with the lens being made of double-refracting material (crystal axis aligned parallel to the optical axis) in the objective pupillary plane 41 on the rays which emanate from a non-axial image point 31. The illumination has a tangential polarization distribution. For rays which pass the objective pupillary plane 41 (by way of example, B1 to B4), the refractive index is no longer constant. Two effects occur:

(1) a modulation of the refractive index occurs in dependence upon the pupillary azimuth (independently of the curvature radii of the lens). This modulation is of sinusoidal shape having the period of180° in the pupil. While the rays B′1 and B′3 have, as before, the proper refractive index n₀, the refractive index for the rays B′2 and B′4 differs from n₀. This modulation leads, in a first approximation, to an astigmatized wavefront deformation (Zernike coefficient Z5 of the fifth order) when passing through the (spherical) lens 42 in the pupillary plane 41. This wavefront error can be adjusted with a precision adjustment of the objective 4.

(2) a double refraction in dependence upon the pupillary azimuth and in dependence upon the angle of incidence on the lens surface (that is, the pupil radius). The double refraction is a maximum for the rays B′2 and B′4 and vanishes for the rays B′l and B′3. This effect is of little consequence in view of the relatively small maximum incidence angles of the rays on the pupillary plane of lithographic projection objectives (order of magnitude of local NA=0.1) and the comparatively small radii of curvature of lenses close to the pupil compared to point (1) and plays a subordinate roll because: (a) the ratio of the extraordinary refractive index to the ordinary refractive index for a ray, which incidents inclined on the lens surface, becomes less by the pupil NA (that is, by at least the factor 10); and, (b) the intensity ratio of the extraordinary ray to the ordinary ray is low because of small refractive angles at the lens passthrough (under 10%). This residual double refraction in such a color-corrective lens leads to a controllable contrast reduction toward the field edge.

The example at the same time shows a laser resonator 11, which generates tangentially polarized light, and lenses 22 and 42 of the invention in the illumination system 2 as well as in the projection objective 4. Any desired component combinations can be realized. An optically single-axis, double-refracting crystal can always be used in a manner wherein it generates no disturbing double-refracting effects.

It is understood that the foregoing description is that of the preferred embodiments of the invention and that various changes and modifications may be made thereto without departing from the spirit and scope of the invention as defined in the appended claims.

What is claimed is:

1. An optical arrangement disposed with respect to an optical axis, the optical arrangement comprising:
a plane perpendicular to said optical axis;
a light source for generating a light beam along said optical axis and the light of said light beam in said plane being polarized either tangentially to said optical axis or radially with respect to said optical axis;
at least one lens mounted in or next to said plane;
said lens being made of single-axis, double-refracting material defining an optical crystal axis; and,
said optical crystal axis being aligned parallel to said optical axis of said optical arrangement.

2. The optical arrangement of claim 1, wherein said single-axis, double-refracting material of said lens is MgF₂.

3. The optical arrangement of claim 1, wherein said plane is a pupillary plane.

4. The optical arrangement of claim 1, wherein said lens takes up said light beam with a numerical aperture of up to 0.1.

5. The optical arrangement of claim 1, wherein said light source is a laser and said laser includes a resonator for coupling out tangentially or radially polarized light.

6. The optical arrangement of claim 1, wherein said lens is a first lens and said material is a first material, said optical arrangement further comprising at least a second lens made of a second material different than that first material.

7. The optical arrangement of claim 6, wherein said second material is crystal.

8. The optical arrangement of claim 7, wherein said crystal is CaF₂.

9. The optical arrangement of claim 7, wherein said crystal is BaF₂.

10. A microlithographic projection exposure system defining an optical axis, said system comprising:
a UV light source for generating a light beam along said optical axis;
an illumination system arranged on said optical axis downstream of said UV light source;
a projection objective arranged downstream of said illumination system; and,
one of said illumination system and said projection objective including an optical arrangement; and,
said optical arrangement including:
a plane perpendicular to said optical axis;
the light of said light beam in said plane being polarized either tangentially to said optical axis or radially with respect to said optical axis;
at least one lens mounted in or next to said plane;
said lens being made of single-axis, double-refracting material defining an optical crystal axis; and,
said optical crystal axis being aligned parallel to said optical axis of said optical arrangement.

11. The system of claim 10, wherein said single-axis, double-refracting material of said lens is MgF₂.

12. The system of claim 10, wherein said plane is a pupillary plane.
